(19) United States
(12) Patent Application Publication
(10) Pub. No.: US 2019/0315553 A1
(43) Pub. Date: Oct. 17, 2019

(54) COOLING PACK INCLUDING CONSUMABLE FOOD PRODUCT AND SYSTEMS AND METHODS FOR OPTIMIZING PACKAGING FOR PERISHABLE ITEMS USING SAME

(71) Applicant: Tovala, Chicago, IL (US)

(72) Inventors: Peter Fiflis, Chicago, IL (US); Keeley Kabala, Elgin, IL (US); David Rabie, Chicago, IL (US); Bryan Wilcox, Chicago, IL (US)

(73) Assignee: Tovala, Chicago, IL (US)

(21) Appl. No.: 15/955,274

(22) Filed: Apr. 17, 2018

(51) Int. Cl. B65D 81/38; B65D 81/18; B65B 55/00; A23L 3/36

(52) U.S. Cl. CPC B65D 81/3825; B65D 81/18; A23V 2002/00; A23L 3/364; B65B 55/00

(57) ABSTRACT

A method of optimizing packaging for shipping a perishable item includes determining a cooling capacity of an insulated package assembly sufficient to maintain a temperature of a perishable item below a threshold temperature throughout shipping. A first volume of a consumable food product is determined such that the insulated package assembly including the perishable item and the first volume of the consumable food product has the determined cooling capacity. The insulated package assembly is assembled by providing an outer container and positioning within the outer container. A cooling pack is positioned within an insulated cavity defined by the insulator. The cooling pack includes the first volume of the consumable food product. A perishable item package is positioned within the insulated cavity proximate the cooling pack. The perishable item package includes the ordered perishable item. The insulated package assembly is shipped to the destination address.

### TECHNICAL FIELD

The present disclosure relates generally to packaging for perishable items.

### BACKGROUND

Year-over-year, e-commerce sales growth has outpaced that of traditional brick-and-mortar industries. Consumers demand convenience, speed, and value provided by e-commerce, and are expanding the type of products that they purchase online instead of in a brick-and-mortar store. Some products that are delivered to consumers, such as food products, are perishable and must be stored below a particular temperature to avoid spoilage. Perishable items are typically shipped in insulated packaging with a cooling pack to keep the temperature of the product sufficiently low during transit to prevent spoilage.

### SUMMARY

Various embodiments relate to a method of optimizing packaging for shipping a perishable item. An example method includes determining a cooling capacity of an insulated package assembly sufficient to maintain a temperature of a perishable item below a threshold temperature over an estimated transit time along a delivery route from a source address to a destination address. A first volume of a consumable food product is determined based on thermal characteristics of the consumable food product, such that the insulated package assembly including the perishable item and the first volume of the consumable food product has the determined cooling capacity. The insulated package assembly is assembled by providing an outer container. An insulator is positioned within the outer container. The insulator defines an insulated cavity. A cooling pack is positioned within the insulated cavity. The cooling pack includes the first volume of the consumable food product. A perishable item package is positioned within the insulated cavity proximate the cooling pack. The perishable item package includes the ordered perishable item. The insulated package assembly is shipped to the destination address.

Various other embodiments relate to a system for shipping a perishable item. An example system includes an insulated package assembly. The insulated package assembly includes an outer container that defines an outer cavity. An insulating layer is positioned within the outer cavity and defines an insulated cavity. A cooling pack is positioned within the insulated cavity. The cooling pack includes a first volume of a consumable food product. The first volume of the consumable food product is structured to maintain the insulated cavity below a threshold temperature for a predetermined time period. A perishable item is positioned within the insulated cavity proximate the cooling pack. The first volume is determined based on thermal characteristics of the consumable food product.

These and other features, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims.

FIG. 1 is a block diagram illustrating a system for shipping a perishable item, according to an example embodiment.

FIG. 2 is a side cross-sectional view of an insulated package of the system of FIG. 1.

FIG. 3 is a side cross-sectional view of a cooling pack of the system of FIG. 1.

FIG. 4 is a side cross-sectional view of a perishable item package of the system of FIG. 1.

FIG. 5 is a flow diagram of a method of optimizing packaging for shipping a perishable item, according to an example embodiment.

FIG. 6 is a flow diagram of a method of determining a minimum volume of a consumable food product to maintain a temperature of a perishable item below a maximum allowed temperature during shipping, according to an example embodiment.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

One problem associated with product packaging—especially insulated packaging for perishable items—is the excessive waste and harmful environmental impact associated with the discarded packaging. For example, cooling packs (also referred to as ice packs or gel packs) used to keep a perishable item cool during transit are typically thrown away after the packaging is opened. Cooling packs are sealed plastic bags that typically include a water-based gel. Even though some coolant pack gels are purportedly non-toxic and water-soluble, some consumers simply throw the cooling packs in the trash instead of thawing and draining the gel, thereby adding significant volume and weight to landfills and causing harm to the environment.

Various embodiments relate to systems and methods for optimizing packaging for perishable items. Some embodiments relate to packaging for a perishable item including a cooling pack filled with a consumable food product. The cooling pack including the consumable food product is cooled or frozen so as to maintain the temperature of the perishable item below a threshold temperature during shipment. In addition to providing cooling for the perishable item, the consumable food product can be consumed and enjoyed by the recipient instead of simply being thrown away as trash. According to various embodiments, the consumable food product may include, for example, a liquid, such as wine, water, juice, cold brew coffee, etc., or a semi-liquid, such as baby food or applesauce. In some embodiments, the cooling pack includes an outer shell formed of food grade material (e.g., food grade plastic). In some embodiments, the outer shell of the cooling pack includes a dispenser or is otherwise structured for easy opening (e.g., via tearing or puncturing). Some embodiments further include a dispensing rack to support at least one cooling pack for easily accessible gravity-fed dispensing.

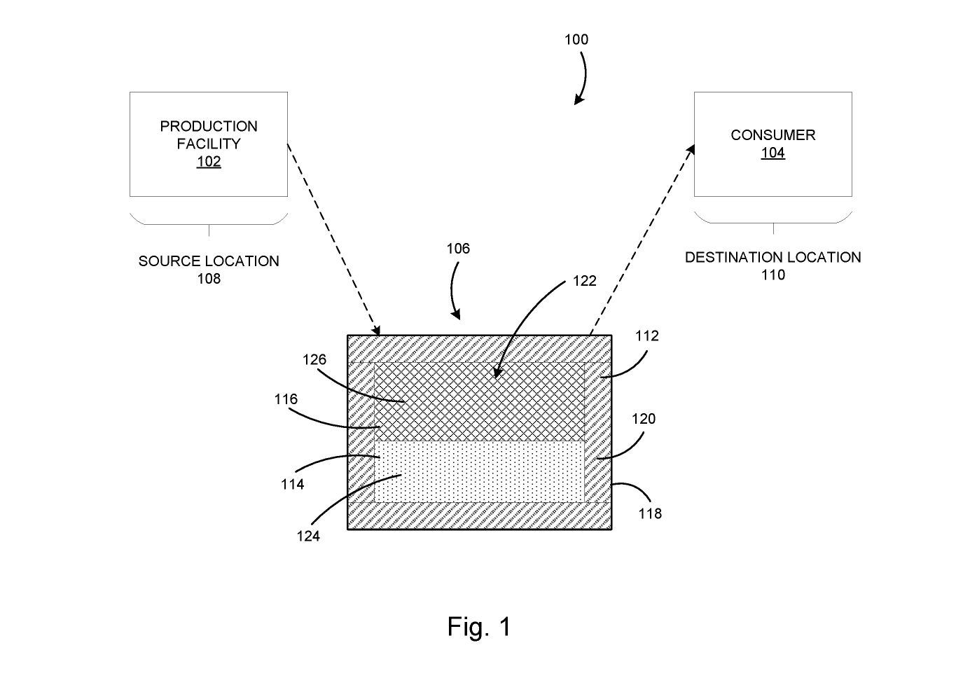

FIG. 1 is a block diagram illustrating a system 100 for shipping a perishable item, according to an example embodiment. The system 100 includes a production facility 102, a consumer 104, and an insulated package assembly 106. The production facility 102 is situated at a source location 108 and the consumer 104 is situated at a destination location 110. Each of the source location 108 and the destination location 110 can be defined by a physical address (e.g., a street address). It should be understood that the destination location 110 corresponds to a fixed address to which the consumer 104 instructs the production facility 102 to ship the insulated package assembly 106.

The insulated package assembly 106 is shown in FIG. 1 in a side cross-sectional view so as to illustrate the various components thereof. The insulated package assembly 106 includes an insulated package 112, a cooling pack 114, and a perishable item package 116. The insulated package 112 includes an outer container 118 and an insulator 120.

The outer container 118 can be formed of corrugated cardboard, plastic, or other suitable packaging materials. The insulator 120 is positioned within the outer container 118 and defines an insulated cavity 122. The insulator 120 can include a foam (e.g., polystyrene), air, or other insulators. The cooling pack 114 is positioned within the insulated cavity 122. The cooling pack 114 includes a consumable food product 124. The perishable item package 116 is positioned within the insulated cavity 122 proximate the cooling pack 114. At least one perishable item 126 is positioned within the perishable item package 116.

In general, the insulated package assembly 106 is structured to maintain a temperature of the perishable item 126 below a threshold temperature over an estimated transit time along a delivery route between the source location 108 and the destination location 110.

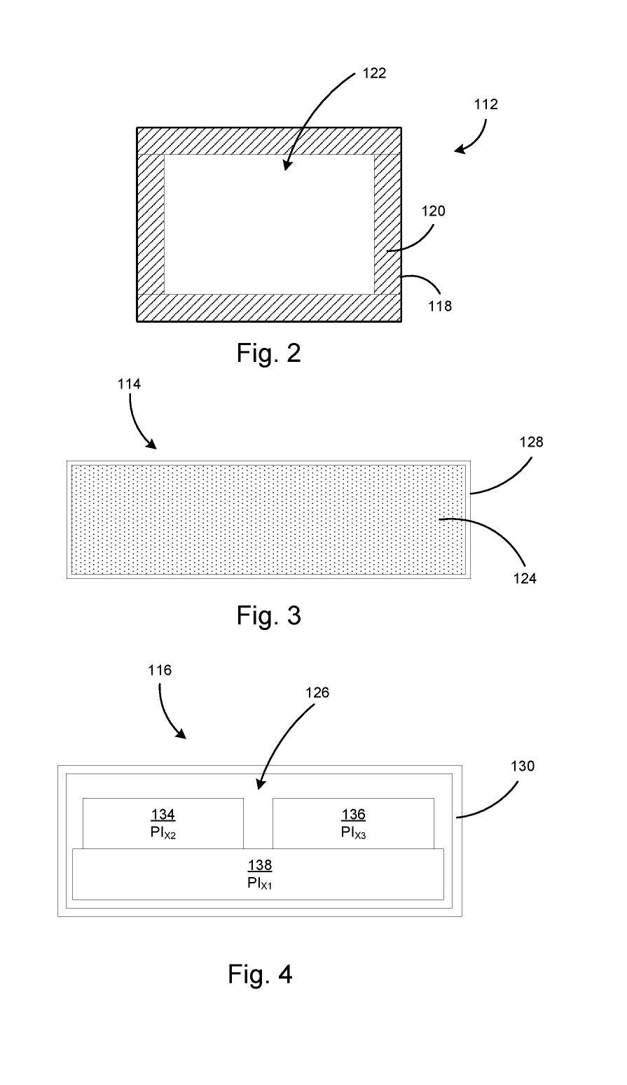

FIG. 2 is a side cross-sectional view of the insulated package 112 of the system 100 of FIG. 1. As shown in FIG. 2, the insulated package 112 includes the outer container 118 and the insulator 120, and defines the insulated cavity 122.

The insulated package 112 has various thermal properties, as shown below in Table 1. For example, insulated package 112 and its components have respective “R-values,” which are measures of how well an object resists conductive flow of heat. The R-value of the outer container 118 is at least R_{OC} 202. The R-value of the insulator 120 is at least R_{INS} 204. The insulated package 112, including the outer container 118 and the insulator 120, has an effective R-value, R_{PACKAGE} 206. According to various embodiments, Any of R_{OC} 202, R_{INS} 204, and R_{PACKAGE} 206 can be determined theoretically or experimentally.

TABLE 1
PROPERTIES OF INSULATED PACKAGE 112

| | |
|---|---|
| R_{OC} 202 | R-value of outer container 118 |
| R_{INS} 204 | R-value of insulator 120 |
| R_{PACKAGE} 206 | R-value of insulated package 112 |

FIG. 3 is a side cross-sectional view of the cooling pack 114 of the system 100 of FIG. 1. The cooling pack 114 includes an outer shell 128 structured to retain the consumable food product 124. In some embodiments, the cooling pack 114 is formed of a food grade material, such as a food grade plastic or a coated paper-based carton.

As noted above, the insulated package assembly 106 (FIG. 1), including the cooling pack 114, which includes the consumable food product 124, provides various technical advantages over traditional insulated package assemblies that utilize cooling packs with non-consumable media. For example, instead of simply throwing the cooling pack away after it performs its function of cooling the perishable item, a consumer can consume and enjoy the consumable food product 124. According to various embodiments, the consumable food product may include any of various types of consumable food products, including liquids, such as wine, water, juice, cold brew coffee, etc., or semi-liquids, such as baby food or applesauce.

The consumable food product 124 has several relevant properties that relate to its ability to provide adequate cooling to the perishable item 126 during transit. For example, the consumable food product 124 has the following properties as set forth below in Table 2 and as shown in FIG. 3. In particular, the consumable food product 124 has a volume V_{CFP} 208, a density ρ_{CFP} 210, and a mass m_{CFP} 212. The consumable food product 124 has two different specific heat values: a specific heat of the consumable food product in solid form c_{CFP,sol} 214 and a specific heat of the consumable food product in liquid form c_{CFP,hq} 216. The consumable food product 124 also has a latent heat of fusion L_{CFP} 218. Finally, the consumable food product 124 has various temperatures from the time of packaging to the time of unboxing. Relevant temperatures include an initial temperature of the consumable food product 124 at the time of packaging T_{0,CFP} 220, the freezing point of the consumable food product 124 T_{Freeze,CFP} 222 (the temperature at which the consumable food product 124 changes from a solid to a liquid), and a maximum allowable temperature of the consumable food product T_{MAX,CFP} 224.

TABLE 2
PROPERTIES OF CONSUMABLE FOOD PRODUCT 124

| | |
|---|---|
| V_{CFP} 208 | Volume |
| ρ_{CFP} 210 | Density |
| m_{CFP} 212 | Mass |
| c_{CFP,sol} 214 | Specific heat in solid form |
| c_{CFP,liq} 216 | Specific heat in liquid form |
| L_{CFP} 218 | Latent heat of fusion |
| T_{0,CFP} 220 | Initial temperature at time of packaging |
| T_{Freeze,CFP} 222 | Freezing point |
| T_{MAX,CFP} 224 | Maximum allowable temperature |

It should be understood that, in some embodiments, the properties outlined above are defined with regard to the overall perishable item package 116, including the consumable food product 124 and the outer shell 128. In some embodiments, the outer shell 128 is negligible with regard to the above-defined properties.

FIG. 4 is a side cross-sectional view of the perishable item package 116 of the system 100 of FIG. 1. The perishable item package 116 includes a container 130 that retains the perishable item 126. In some embodiments, the container 130 is formed of a food grade material, such as aluminum or a food grade plastic. In some embodiments, the container 130 is an assembly that includes several sub-containers and/or other packaging.

According to various embodiments, the perishable item 126 may include one or more perishable item components. For example, in the example embodiment illustrated in FIG. 4, the perishable item 126 includes a first perishable item component PI_{X1} 132, a second perishable item component PI_{X2} 134, an third perishable item component PI_{X3} 136. It should be understood that, according to various embodiments, the perishable item 126 may include N (any number of) perishable item components.

According to various embodiments, the perishable item 126 may be a consumable food product or a product that is not intended for human consumption (e.g., blood, semen, etc.). For example, in one embodiment, the perishable item 126 is a food product, such as a meal kit, that includes one or more food items. For example, in the embodiment illustrated in FIG. 4, the first perishable item component 132 may be a grain, the second perishable item component 134 may be a vegetable, and the third perishable item component 136 may be a protein.

Similar to the consumable food product 124 described above, the perishable item 126 has several relevant properties that relate to the ability of the overall insulated package assembly 106 to provide adequate cooling to the perishable item 126 during transit. For example, the perishable item 126 has the following properties as set forth below in Table 3 and as shown in FIG. 4.

In particular, the perishable item 126 has a mass m_{PI} 226. The perishable item 126 has two different specific heat values: a specific heat of the perishable item in solid form c_{PI,sol} 228 and a specific heat of the perishable item in liquid form c_{PI,liq} 230. The perishable item 126 also has a latent heat of fusion L_{PI} 232. Finally, the perishable item 126 has various temperatures from the time of packaging to the time of unboxing. Relevant temperatures include an initial temperature of the perishable item 126 at the time of packaging T_{0,PI} 234, the freezing point of the perishable item 126 T_{Freeze, PI} 236 (the temperature at which the perishable item 126 changes from a solid to a liquid), and a maximum allowable temperature of the perishable item 126 T_{MAX, PI} 238.

TABLE 3
PROPERTIES OF PERISHABLE ITEM 126

| | |
|---|---|
| m_{PI} 226 | Mass |
| c_{PI,sol} 228 | Specific heat in solid form |
| c_{PI,liq} 230 | Specific heat in liquid form |
| L_{PI} 232 | Latent heat of fusion |
| T_{0,PI} 234 | Initial temperature at time of packaging |
| T_{Freeze,PI} 236 | Freezing point |
| T_{MAX,PI} 238 | Maximum allowable temperature |

It should be understood that the properties outlined above can be expressed in terms of the overall perishable item package 116 including the perishable item 126 and the container 130, in terms of the entire perishable item 126, or individually with respect to each of the perishable item components of the perishable item 126, such as the first, second, and third perishable item components 132, 134, 136 of FIG. 3. Each of the properties may be the same or different with respect to each of the first, second, and third perishable item components 132, 134, 136.

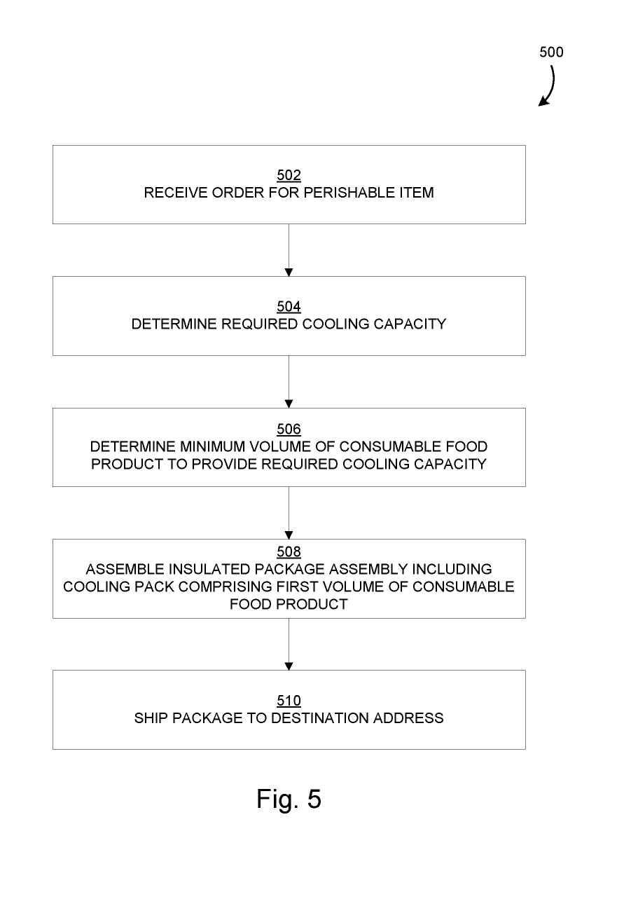

FIG. 5 is a flow diagram of a method 500 of optimizing packaging for shipping a perishable item, according to an example embodiment. At 502, an order for a perishable item is received. The order includes a destination address to which the perishable item is to be shipped. The perishable item can be a consumable food product or a non-consumable food product. For example, in one embodiment, the perishable item is a meal kit including a collection of uncooked or par-cooked ingredients. The perishable item is to be shipped from a source address (e.g., at a production or distribution facility) to the destination address (e.g., a consumer's residential address) in an insulated package assembly structured to maintain a temperature of the perishable item below a threshold temperature over an estimated transit time along a delivery route from a source address to a destination address.

In some embodiments, a cooling pack filled with a consumable food product is placed within the insulated package assembly to provide sufficient cooling capacity so as to maintain the temperature of the perishable item below the threshold temperature during shipment. According to various embodiments, the consumable food product includes at least one of a liquid food product and a semi-liquid food product. The consumable food product is cooled or frozen within the cooling pack prior to assembling the insulated package assembly.

In some embodiments, the delivery route for delivering the perishable item from a source address (e.g., at a production or distribution facility) to the destination address (e.g., a consumer's residential address) is mapped. In some embodiments, mapping includes estimating the transit time for delivering the perishable item. As will be appreciated, the estimated transit time can be used for determining the cooling capacity of the consumable food product. In some embodiments, mapping further includes estimating ambient temperatures to which the insulated package assembly is to be exposed during transit along the delivery route. For example, in some embodiments, the ambient temperatures to which the insulated package assembly is to be exposed are determined based on weather forecast data for the delivery route.

At 504, a required cooling capacity is determined. The required cooling capacity is a cooling capacity of the insulated package assembly that is sufficient to maintain the temperature of the perishable item below the threshold temperature over the estimated transit time along the delivery route from the source address to a destination address. Put another way, the required cooling capacity relates to a maximum amount of heat that can be transferred to the perishable item 126 during transit such that a final temperature of the perishable item 126 at the time that the perishable item is removed from the insulated package 112 (unboxed) by the consumer 104 at the destination location 110 does not exceed the maximum allowable temperature of the perishable item T_{MAX, PI} 238.

In some embodiments, the cooling capacity of the insulated package assembly comprises a first cooling capacity of the perishable item and a second cooling capacity of the consumable food product. The first cooling capacity of the perishable item is determined based on at least a volume, a heat of fusion, a specific heat, and an initial temperature of the perishable item.

In some embodiments, the perishable item includes multiple components. For example, in one embodiment, the perishable item includes a first perishable item component and a second perishable item component. In this arrangement, the first cooling capacity of the perishable item is a sum of the cooling capacities of the first and second perishable item components. For example, a third cooling capacity of the first perishable item component is determined based on at least a volume, a heat of fusion, a specific heat, and an initial temperature of the first perishable item component. A fourth cooling capacity of the second perishable item component is determined based on at least a volume, a heat of fusion, a specific heat, and an initial temperature of the second perishable item component. The first cooling capacity of the perishable item is a sum of the third cooling capacity of the first perishable item component and the fourth cooling capacity of the second perishable item component.

In some embodiments, the total heat load on the perishable item and the consumable food product during transit from the source address to the destination address along the delivery route is determined and utilized to determine the required cooling capacity of the consumable food product. In some embodiments, the total heat load is determined based on the estimated transit time and ambient temperatures to which the insulated package assembly is to be exposed during transit along the delivery route over the estimated transit time, and thermal properties of the outer container and the insulating layer. In some embodiments, the cooling capacity of the consumable food product is a difference between the total heat load and the first cooling capacity of the perishable item.

At 506, a volume of the consumable food product needed to provide the required cooling capacity is determined. The volume of the consumable food product is determined based on the thermal characteristics of the consumable food product, such that the insulated package assembly including the volume of the consumable food product has the cooling capacity determined to be sufficient. In some embodiments, the volume of the consumable food product is determined so as to provide the required cooling capacity of the consumable food product based on a heat of fusion, a specific heat, and an initial temperature of the consumable food product.

At 508, the insulated package assembly including the cooling pack, which includes the determined volume of the consumable food product, is assembled. Assembling the insulated package assembly includes providing an outer container. An insulator is positioned within the outer container. The insulator defines an insulated cavity. The cooling pack is positioned within the insulated cavity. The cooling pack includes the determined volume of the consumable food product. A perishable item package is positioned within the insulated cavity proximate the cooling pack. The perishable item package includes the ordered perishable item.

In some embodiments, the cooling pack includes multiple cooling pack portions that, combined, provide the determined volume of the consumable food product. For example, in an embodiment, the cooling pack includes a first cooling pack portion and a second cooling pack portion. The volume of the consumable food product is distributed between the first and second cooling pack portions.

At 510, the insulated package assembly is shipped to the destination address. The cooling pack within the insulated package assembly provides the required amount of cooling such that the temperature of the perishable item is maintained below the threshold temperature over the estimated transit time along the delivery route from the source address to the destination address so as to prevent spoilage of the perishable item.

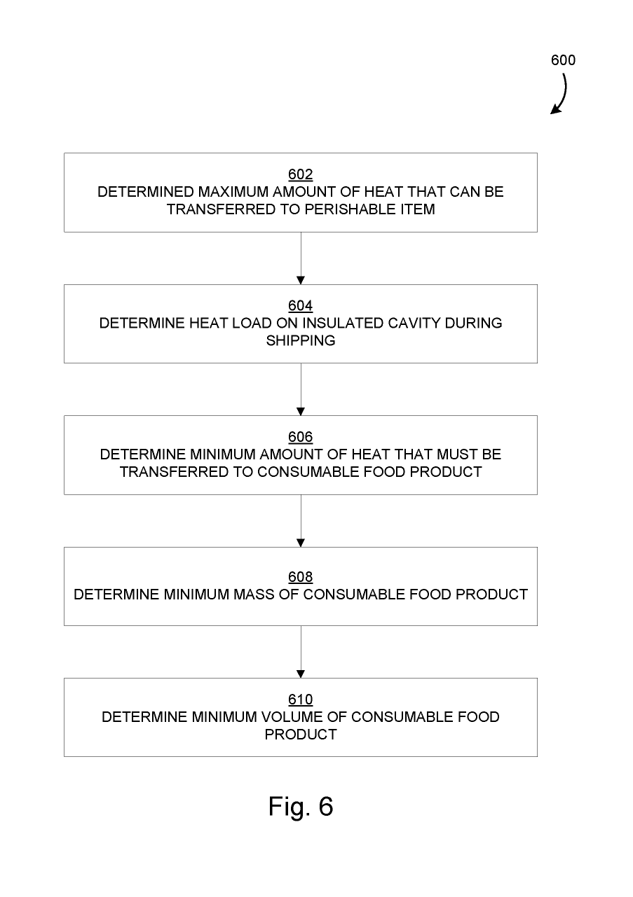

FIG. 6 is a flow diagram of a method 600 of determining a minimum volume of a consumable food product to maintain a temperature of a perishable item below a maximum allowed temperature during shipping, according to an example embodiment. The method 600 of FIG. 6 essentially comprises steps 504 and 506 of the method 500 of FIG. 5. For the purposes of clarity, the method 600 will be described with regard to the system 100 of FIG. 1, the insulated package 112 of FIG. 2, the consumable food product 124 of FIG. 3, and the perishable item 126 of FIG. 4. However, the method 500 can be performed similarly using other systems and devices.

At 602, a maximum amount of heat that can be transferred to the perishable item 126, Q_{PI}, is determined. Q_{PI} depends on various factors, such as the mass of the perishable item m_{PI} 226, the specific heat of the perishable item 126 in solid form c_{PI,sol} 228, the specific heat of the perishable item 126 in liquid form c_{PI,liq} 230, the latent heat of fusion of the perishable item 126 L_{PI}232, the initial temperature of the perishable item 126 at the time of packaging T_{0,PI} 234, the freezing point of the perishable item 126 T_{Freeze, PI} 236, and the maximum allowable temperature of the perishable item 126 T_{MAX, PI} 238. For example, in one embodiment, Q_{PI} is determined using equation 1 set forth below.

Q_{PI}=m_{PI}c_{PI,sol}(T_{FREEZE,PI}−T_{0,PI})+L_{PI}m_{PI}+m_{PI}c_{PI,liq}(T_{MAX,PI}−T_{FREEZE,PI}) (1)

It should be understood that equation 1 is set forth in terms of an overall perishable item 126. As mentioned above, in some embodiments, the perishable item 126 includes multiple perishable item components. The maximum amount of heat that can be transferred to each of the perishable item components can be determined individually. For example, in one embodiment, the maximum heat that can be transferred to the first perishable item component 132, Q_{PI,X1}, is determined using equation 2 set forth below.

Q_{PI,X1}=m_{PI,X1}c_{PI,sol,X1}(T_{FREEZE,PI,X1}−T_{0,PI,X1})+L_{PI,X1}m_{PI,X1}+m_{PI,X1}c_{PI,liq,X1}(T_{MAX,PI,X1}−T_{FREEZE,PI,X1}) (2)

It should be appreciated that the maximum amount of heat that can be transferred to the other perishable item components can be determined in a similar manner. The maximum amount of heat that can be transferred to the entire perishable item 126 is the sum of the maximum amounts of heat that can be transferred to each respective perishable item component.

At 604, a heat load on the insulated cavity 122 during shipping, Q_{load}, is determined. Q_{load} depends on several factors, such as the ambient temperature during shipping, the temperature of the frozen consumable food product 126, and the R-value of the packaging. For example, in one embodiment, Q_{load} is determined using equation 3 set forth below.

$${Q}_{load} = {\int }_{{t}_{shipped}}^{{t}_{unboxed}} \frac{{T}_{ambient} - {T}_{freeze , cfp}}{{R}_{packaging}} dt \qquad ( 3 )$$

At 606, a maximum amount of heat that can be transferred to the consumable food product 126 during shipping, Q_{CFP}, is determined. As set forth below in equation 4, the Q_{CFP} is the difference between Q_{load} and the Q_{PI} for all of the perishable item components.

$${Q}_{CFP} = {Q}_{load} - {\sum }_{n} {Q}_{PI , Xn} \qquad ( 4 )$$

At 608, the minimum mass of the consumable food product 126 is determined. The minimum mass refers to a mass of the consumable food product 126 that is necessary to maintain a temperature of the perishable item 126 below a maximum allowed temperature during shipping, according to an example embodiment. Equation 2 can be re-written with regard to the consumable food product 124, as set forth below in equation 5.

Q_{CFP}=m_{CFP}c_{CFP,sol}(T_{FREEZE,CFP}−T_{0,CFP})+L_{CFP}m_{CFP}+m_{CFP}c_{CFP,liq}(T_{MAX,CFP}−T_{FREEZE,CFP}) (5)

Given Q_{CFP}, as determined above using equation 4, equation 5 can be solved for the minimum mass of the consumable food product, m_{CFP}.

At 610, the minimum volume of the consumable food product 126 is determined. The minimum volume of the consumable food product, V_{min,CFP} is simply the mass of the consumable food product divided by its density, or m_{CFP}/ρ_{CFP}.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

What is claimed is:

1. A method, comprising:
determining a cooling capacity of an insulated package assembly sufficient to maintain a temperature of a perishable item below a threshold temperature over an estimated transit time along a delivery route from a source address to a destination address;
determining a first volume of a consumable food product based on thermal characteristics of the consumable food product, such that the insulated package assembly including the perishable item and the first volume of the consumable food product has the determined cooling capacity;
assembling the insulated package assembly, comprising:
providing an outer container,
positioning an insulator within the outer container, the insulator defining an insulated cavity,
positioning a cooling pack within the insulated cavity, the cooling pack including the first volume of the consumable food product, and
positioning a perishable item package within the insulated cavity proximate the cooling pack, the perishable item package including the ordered perishable item; and
shipping the insulated package assembly to the destination address.

2. The method of claim 1, further comprising freezing the consumable food product within the cooling pack prior to the assembling of the insulated package assembly.

3. The method of claim 1, further comprising:
receiving an order for the perishable item, the order including the destination address; and
mapping the delivery route for delivering the perishable item to the destination address from the source address, the mapping including estimating the transit time for delivering the perishable item, the estimated transit time being used for the determining of the cooling capacity of the consumable food product.

4. The method of claim 3, further comprising receiving weather forecast data for the delivery route,
wherein the mapping further includes estimating ambient temperatures to which the insulated package assembly is to be exposed during transit along the delivery route.

5. The method of claim 1,
wherein the cooling capacity of the insulated package assembly comprises a first cooling capacity of the perishable item and a second cooling capacity of the consumable food product, and
wherein the first cooling capacity of the perishable item is determined based on at least a volume, a heat of fusion, a specific heat, and an initial temperature of the perishable item.

6. The method of claim 5,
wherein the perishable item comprises a first perishable item component and a second perishable item component,
wherein the determining of the first cooling capacity of the perishable item comprises:
determining a third cooling capacity of the first perishable item component based on at least a volume, a heat of fusion, a specific heat, and an initial temperature of the first perishable item component;
determining a fourth cooling capacity of the second perishable item component based on at least a volume, a heat of fusion, a specific heat, and an initial temperature of the second perishable item component;
wherein the first cooling capacity of the perishable item is a sum of the third cooling capacity of the first perishable item component and the fourth cooling capacity of the second perishable item component.

7. The method of claim 5, further comprising:
determining total heat load on the perishable item and the consumable food product during transit from the source address to the destination address along the delivery route based on the estimated transit time and ambient temperatures to which the insulated package assembly is to be exposed during transit along the delivery route over the estimated transit time, and further based on thermal properties of the outer container and the insulating layer,
wherein the determining of the second cooling capacity of the consumable food product is a difference between the total heat load and the first cooling capacity of the perishable item.

8. The method of claim 7, wherein the determining of the first volume of the consumable food product comprises calculating the first volume of the consumable food product necessary to provide the second cooling capacity of the consumable food product based on a heat of fusion, a specific heat, and an initial temperature of the consumable food product.

9. The method of claim 1,
wherein the cooling pack comprises a first cooling pack portion and a second cooling pack portion, and
wherein the first volume of the consumable food product is distributed between the first and second cooling pack portions.

10. The method of claim 1,
wherein the cooling pack has a minimum volume capacity and a maximum volume capacity, and
wherein the consumable food product is selected from a plurality of candidate food products, the plurality of candidate food products each having respective thermal characteristics, wherein the consumable food product is one of the plurality of candidate food products for which the first volume is within the minimum and maximum volume capacity of the cooling pack.

11. The method of claim 1, wherein the consumable food product includes at least one of a liquid food product and a semi-liquid food product.

12. A system, comprising:
an insulated package assembly, comprising:
an outer container defining an outer cavity;
an insulating layer positioned within the outer cavity and defining an insulated cavity; and
a cooling pack positioned within the insulated cavity, the cooling pack comprising a first volume of a consumable food product, the first volume of the consumable food product structured to maintain the insulated cavity below a threshold temperature for a predetermined time period; and
a perishable item positioned within the insulated cavity proximate the cooling pack,
wherein the first volume is determined based on thermal characteristics of the consumable food product.

13. The system of claim 12, wherein the first volume of the consumable food product is frozen in the cooling pack prior to positioning the cooling pack within the insulated cavity.

14. The system of claim 12, further comprising a cooling optimization computing system structured to:
receive an order for the perishable item, the order including a destination address; and
map a delivery route for delivering the insulated package assembly including the perishable item to the destination address from a source address, the mapping including estimating a transit time for delivering the perishable item,
wherein the predetermined time period includes the transit time.

15. The system of claim 14, wherein the cooling optimization computing system is further structured to:
determine a cooling capacity sufficient to maintain the insulated cavity below the threshold temperature for the predetermined time period, and
determine the first volume of the consumable food product based on thermal characteristics of the consumable food product, such that the insulated package assembly including the first volume of the consumable food product has the determined cooling capacity.
